(19) United States
(12) Patent Application Publication
(10) Pub. No.: US 2009/0305219 A1
(43) Pub. Date: Dec. 10, 2009

(54) APPARATUS, AND ASSOCIATED METHOD, FOR PROVIDING PERSONALIZED CONTENT TO AN EXHIBIT-AREA GUEST

(75) Inventor: MATTHEW A. STUEMPFLE, RALEIGH, NC (US)

Correspondence Address: DOCKET CLERK, P.O. BOX 12608, DALLAS, TX, 75225, US

(73) Assignee: ELECTONIC DATA SYSTEMS CORPORATION, PLANO, TX (US)

(21) Appl. No.: 12/132,858

(22) Filed: Jun. 4, 2008

(51) Int. Cl. G09B 25/00

(52) U.S. Cl. 434/365

(57) ABSTRACT

An apparatus, and an associated method, for providing personalized content to a guest at an exhibit area. Content is collected and stored that is associated with exhibits of the exhibit area. The exhibit content is formed of content portions that are tagged with identifiers. The identifiers correspond with categories of guest, demographic information. When a guest enters the exhibit area, demographic information associated with the guest is used to create personalized content that is played out to the guest by way of a guest device carried by the guest when the guest is detected by an exhibit node detector to be in vicinity of an exhibit.

The present invention relates generally to a manner by which to facilitate personalization of content, such as content provided to a guest that tours a museum, or other exhibit, area. More particularly, the present invention relates to an apparatus, and an associated method, by which to provide a content stream to the guest when the guest is in proximity of an exhibit in the exhibit area. The content stream includes content personalized to the guest, e.g., based upon demographic data associated with the guest. The content is dynamically selected and, if desired, further includes dynamically retrieved content, such as from a remote, internet-connected location.

### BACKGROUND OF THE INVENTION

Exhibit providers, such as museum curators and the like, regularly provide information to guests as the guests are viewing the exhibits. The information adds context to the exhibits and results in an improved guest experience. Most simply, the additional information comprises textual data that is positioned proximate to an exhibit that the data describes. When a guest views an exhibit, the guest is able also to read the textual data to obtain information about the exhibit. When the exhibit area includes multiple exhibits, and each of the exhibits includes textual material, the guest obtains additional information about each of the exhibits by reading the textual material associated with the individual ones of the exhibits.

Textual information presented in this conventional manner is popular as the textual data is easily obtained and is also easily, and inexpensively, presented and maintained. However, the presented, textual data is static and at least semi-permanent. And, if there are numerous guests attempting to view the textual data associated with the exhibit at the same time, some of the guests' viewing of the textual data might be blocked by other guests, and the exhibit experience of some of the guests might be diminished. Additionally, the textual data is language-specific. Only guests that understand the language in which the textual data is presented are able to read the presented information. A guest that is unable to understand the language in which the textual data is presented, or if the guest suffers from a visual impairment, the guest is not provided with the information of the textual data.

Exhibit presenters sometimes additionally, or alternately, provide audio information to the guests. In some implementations, a switch is actuated by a guest, and stored, audio information proximate to the exhibit is played out. Or, rather than requiring a guest at the exhibit to actuate a switch to start the play out of the audio text, a proximity sensor senses the proximity of the guest to the exhibit, and the audio text is played out when the guest is detected to be proximate to the exhibit. In some other implementations, the guest is provided with an audio-content, play-out device such as a cassette-tape player or digital-content player, when visiting the exhibit area. The guest carries the audio content play-out device during a tour of the exhibit area. The guest causes play-out of the stored content associated with a particular exhibit in the exhibit area when the guest is positioned in proximity to the exhibit.

When the guest uses a cassette-tape type of play out device, the guest typically follows a set path from exhibit to exhibit in the exhibit area corresponding to the play-out sequence of the recorded audio text. The use of a digital play-out device facilitates better guest mobility, that is to say, a guest is better able to select in which exhibit order to view the exhibits and play out audio content associated with the exhibits. But, the pre-recorded audio information is typically a static play out of information. That is, the audio is pre-recorded, and the identical information is played-out to each guest. And, if a guest visits the exhibit, new information is not provided to the guest. Rather, the guest is limited to again hearing the same audio content.

In whatsoever, conventional manner by which the additional information is provided to the guest, i.e., textual, aural, or other, the information is statically-presented. Guest satisfaction with the additional information quite possibly is diminished, particularly if the guest views the exhibit more than one time. Additionally, if the content is provided in a manner that limits guests to a single viewing sequence of exhibits in the exhibit area, bottlenecks and queues might occur. The bottlenecks and queues could be alleviated but for the need to maintain a fixed viewing sequence due to the play-out of the content. Efforts have been made by which to facilitate a guest flow at an exhibit area. For instance, U.S. Pat. No. 7,212,983 discloses a manner for providing visitors with a personalized itinerary. And, U.S. Pat. No. 7,240,108 pertains to customized tours using hand held devices. However, these existing efforts have not adequately overcome problems associated with the use of static content, provided in conventional manner.

If a manner could be provided by which to provide more dynamic and personalized information to a guest at an exhibit area, an improved guest experience would result.

It is in light of this background information that the significant improvements of the present invention have evolved.

### SUMMARY OF THE INVENTION

The present invention, accordingly, advantageously provides an apparatus, and an associated methodology, by which to facilitate personalization of content, such as content provided to a guest that tours a museum, or other exhibit, area.

Through operation of an embodiment of the present invention, a manner is provided by which to provide a content stream to the guest when the guest is in proximity to an exhibit of the exhibit area.

In one aspect of the present invention, guest-related information is provided to the exhibit curator or operator upon, or prior to, entry to the exhibit area. Demographic information, such as the age of the guest, the gender of the guest, the residence of the guest, language preference, etc. is provided. And, the guest is assigned a unique identifier. Entry of the provided information is made, e.g., by way of a user interface of a computer station such as a network-connected computer station. When network-connected, the unique guest identifier that is provided to the guest is provided, e.g., by another network node, to the network-connected computer station at which the registration information is input.

In another aspect of the present invention, the demographic information associated with the guest is provided to a network node. The information with which the guest is associated is indexed together with a guest unique identifier that uniquely identifies the guest. The network node comprises, for instance, a central server that is provided with communication connectivity to the internet and internet-connected devices.

In another aspect of the present invention, the central server, or other network node, stores exhibit content information associated with exhibits at the exhibit area. The exhibit content is collected, or otherwise input, and stored at a storage element of the node. The exhibit content includes textual data and, selectively, also dynamically-obtainable data, such as data retrievable by way of internet connections to remote devices. The dynamically-obtainable information is, e.g., identified by a URL of a device connected to the internet. The exhibit content, once stored, is updatable, and the exhibit content is tagged with tag identifiers that identify portions of the content that are dynamic.

In another aspect of the present invention, the tagged identifiers that are indexed together with portions of the exhibit content are categorized by the demographic data associated with the guests that register, or otherwise provide information, to the exhibit operator or curator. For instance, if the guest demographic information includes an age, or age bracket, a tagged indicator associated with portions of the exhibit content is potentially also of an age or age bracket indication. And, additional portions of the exhibit content are tagged in other manners, such as to indicate portions of the content to be associated with guests of all demographic types. In another aspect of the present invention, proximity detectors are positioned together with the exhibits of the exhibit area. The proximity detectors detect when a guest is in proximity to an exhibit. The proximity detectors further provide indications of the detected proximities to the central server or other node. Detection is made by the proximity detectors as a guest carries a device, such as a transponder-like device or a transceiver, that transmits beacons or signals including identification information, that identifies the proximity of the guest to the exhibit as well as the unique identity of the guest.

In another aspect of the present invention, the central server or other node further includes a text to speech (TTS) processor that operates to convert textual data into audio-stream data. Once converted, the audio-stream data is available for delivery to an audio-data stream transducer located at a device located in proximity to an exhibit node and available thereat to be transduced into acoustic form.

In another aspect of the present invention, the textual data that is converted by the text to speech processor comprises exhibit content that is retrieved from the memory element at which the exhibit content is stored. A selector selects the exhibit content that is to be retrieved and converted into the audio-stream data. Selection is made responsive to an indication of at which of the exhibit-node devices that proximity of the guest is detected. Additionally, selection is made responsive to the demographics of the guest whose proximity has been detected. That is to say, the profile of the guest is utilized in the selection of the exhibit content that is retrieved and converted into the audio-stream data. The tags that are associated with certain of the portions of the exhibit content correspond in type to various of the demographic information categories. And, selection is made by the selector of portions of exhibit content associated with a particular exhibit in whose proximity that the guest is positioned that are identified by tags corresponding to the demographics of the guest. Thereby, data that is considered to be most appropriate, most interesting, or otherwise of greatest value to the guest is selected. The content is retrieved, converted into audio-stream data, and forwarded on to an appropriate exhibit-node device to be transduced into acoustic form, or forwarded on to a guest device and transduced thereat. Different content is thereby able to be personalized and provided to each guest in proximity to an exhibit. The guest experience is enhanced as the guest is provided with information personalized to the guest's demographics.

In these and other aspects, therefore, an apparatus, and an associated method, is provided for providing personalized, guest-terminated content at an exhibit area having a set of exhibits. An exhibit content depository is configured to store exhibit content associated with each exhibit of the set of exhibits. A demographic data depository is configured to store guest demographic data. A content provider is configured to provide, at the exhibit area by way of a radio interface, exhibit information based upon the exhibit content stored at the exhibit content depository and guest demographic data stored at the demographic data depository.

A more complete appreciation of the scope of the present invention and the manner in which it achieves the above-noted and other improvements can be obtained by reference to the following detailed description of presently-preferred embodiments taken in connection with the accompanying drawings that are briefly summarized below, and by reference to the appended claims.

### BRIEF DESCRIPTION OF THE DRAWINGS

FIG. 1 illustrates a functional block diagram of an exemplary area in which embodiment of the present invention is operable.

FIG. 2 illustrates a message sequence diagram representative of signaling generated pursuant to operation of an embodiment of the present invention.

FIG. 3 illustrates a message sequence diagram, also representative of signaling generated pursuant to operation of an embodiment of the present invention.

FIG. 4 illustrates a method flow diagram representative of the method of operation of an embodiment of the present invention.

### DETAILED DESCRIPTION

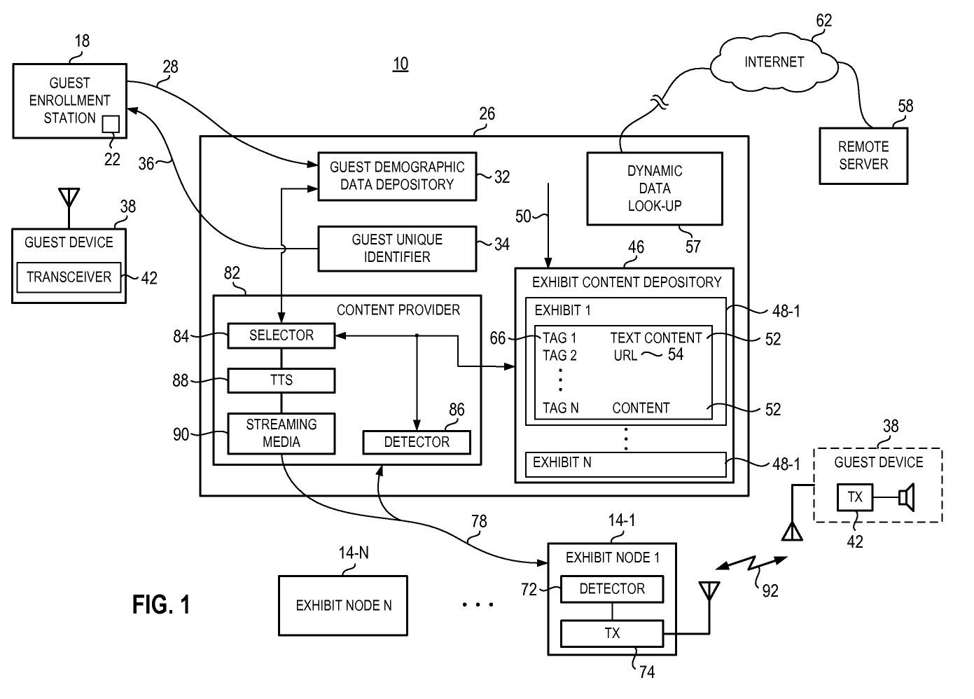

Turning first, therefore, to FIG. 1, an exhibit area, shown generally at 10, is representative of a museum, or other, exhibit area at which exhibits are displayed. The following description shall describe exemplary operation in which the exhibit area includes a plurality of exhibits, each exhibit associated with an exhibit node 14, of which N exhibit nodes 14 are shown in FIG. 1. More generally, the exhibit area is representative of any of the various display areas at which displays are presented.

In the exemplary implementation, entry to the exhibit area is controlled or otherwise monitored. Guests enter the exhibit area by way of an exhibit area entryway at which the guest provides demographic information. The demographic information includes, e.g., the age of the guest, the gender of the guest, the residence location or background of the guest, etc. Here, the guest demographic information is entered by way of a guest enrollment station 18. The station 18 comprises, e.g., a computer work station at which the guest demographic information is entered, such as through entry by an agent of the exhibit operator or curator that manages the exhibit. The guest demographic information is entered pursuant to execution of an enrollment application 22 resident at, or available to, the guest enrollment station. The station 18 is a network-connected device, here connected to a central server 26. The central server 26 is provided, indicated by the segment 28 to the central server and stored at a guest demographic data depository 32. The central server further includes a guest identifier 34 that uniquely identifies the guest. The demographic information stored at the demographic data depository is, for instance, indexed together the guest identifier. And, when assigned, an indication of the identifier is provided, indicated at 36, to the guest enrollment station. The unique identifier is, in turn, provided to a guest device 38 that is carried by, or otherwise provided to, the guest. The identifier is provided to the guest device 38 by way of a wired connection or by way of a radio interface. In the exemplary implementation, and as shall be described below, the guest device 38 includes a transceiver 42 capable of transceiving, or at least receiving, content data.

The central server further includes an exhibit content depository 46 that operates to store exhibit content. In the exemplary implementation, each of the N exhibits with which the N exhibit nodes 14 are associated, respectively, has content stored at the exhibit content depository that is of relevance to the associated exhibit. Here, content 48-1 pertains to the exhibit associated with the exhibit node 14-1. The content includes textual content, here represented to be provided by way of the line 50. The textual content is, e.g., keyed in to the central server or copied therein. Textual content is represented at 52. Pursuant to an exemplary embodiment, the exhibit content further includes dynamically-obtainable content, here represented by a URL 54. The URL is a worldwide web address or IP (internet protocol) representation thereof that provides for retrieval of content from a remote node by way of functionality of a data look-up entity 57. The remote node is here represented by the server 58, placeable in communication connectivity with the central server by way of the internet 62 or other network.

Different portions of the content associated with an exhibit are tagged with tag identifiers 66. The tag identifiers are of tag-types corresponding to the demographic-information types of the demographic information associated with guests of the exhibit 10. For instance, various of the tags 66 are associated with ages or age brackets; others of the tags are associated with genders; others of the tags are associated with residences or other geographical locations or areas; and others are associated with our demographic, and other, categories. Tag identifiers are associated with both textual content and dynamically-obtainable content.

The exhibit nodes each include a proximity detector 72 and transceiver circuitry 74. The proximity detector operates to detect proximity of a user device 38 and, in an exemplary implementation, is coupled to the transceiver circuitry to make detections responsive to detected signals of a guest device. The detected signals are, e.g., transponder signals. The exhibit node at which the proximity of a guest device is detected generates signals that are provided to the central server, here indicated by way of the lines 78.

The central server further includes a content provider 82 that here includes the functionalities of a selector 84, a detector 86, a text to speech (TTS) processor 88, and a streaming media entity 90. The content provider operates to provide content to an exhibit node to permit the exhibit node, in turn, to send, by way of a radio air interface 92, selected content to a guest device 38 for play out of the provided content.

The guest location data detector 86 detects the indications of detected proximity detected by the detector 72 of an exhibit node. In response, the selector 84 selects content from the exhibit content depository that is to be provided to the exhibit node for subsequent play out at the guest device. The selection is responsive to the particular exhibit node at which the proximity detection is made as well as the identity of the guest, evidenced by the guest unique identifier that has been assigned to the guest. The unique identifier is sent by way of the radio air interface 92 and is detected at the exhibit node. The selector accesses the demographic data depository and obtains demographic information stored thereat associated with the identified, unique guest identifier. The accessed information is compared with tag identifiers 66 associated with the different portions of the exhibit content associated with the particular exhibit. If the tag identifier corresponds with a retrieved demographic, the corresponding content is retrieved. In the event that the corresponding content is dynamically-obtainable content 54, the data is retrieved by way of the functionality of the data look-up entity 57.

The retrieved content is provided to the text to speech processor 88 that converts the retrieved textual data into audio-stream data. The audio-stream data is provided to a streaming mode entity 90 that streams the audio-streamed data to the exhibit node 14 and, in turn, by way of the radio air interface 92, to the guest device 38 to be played out thereat. An acoustic transducer at the guest devices comprises, for instance, headphones or a head set worn by the guest.

Because the exhibit data that is streamed to the guest is personalized depending upon the demographic data associated with the guest, the guest experience at the exhibit is enhanced. And, through the use of dynamically-obtainable data, the retrievable content is readily changed, as conditions warrant.

In operation, the operator of the exhibit 10 develops a narrative, i.e., text for each exhibit at the exhibit area and enters the narrative into a central application. The content is tagged with tag identifiers, and the tag identifiers form specific place holders to indicate where dynamic content shall be inserted as part of an audio generation process. The place holder tags are linked to a reference as to where to obtain the dynamic data, e.g., an internet site, a web service, a table of information, etc. In one implementation, a default replacement value is further utilized, used in the event that dynamic data is not returned in response to a data look up or request.

A guest subsequently enters demographic information at an enrollment station. The demographic information forms, e.g., a profile. The requested demographic information corresponds in type with the tag identifiers that are applied to the exhibit narrative. The demographic information, once entered, is provided to the central server for storage thereat. The central server generates a unique identifier for the guest, and the unique identifier is provided to a portable guest device, i.e., a guest node, and the guest node is activated, identified with the unique guest identifier.

The guest walks, or otherwise passes, through the exhibit area. The guest device transmits and receives information with transceivers positioned at the exhibit nodes. Triangulation is performed, or otherwise, and the relative proximity of a guest to an exhibit node is detected. When the guest is in close-enough proximity to an exhibit node, the unique guest identifier is transmitted to the exhibit node and then relayed to the central server.

By knowing the exhibit node at which the proximity is detected, together with the identification of the guest unique identifier, the guest profile and an exhibit narrative is located. Tag identifiers of the narrative are matched against the demographic data of the guest profile. For each tag identifier, query is made of the data source linked to the tag, and the guest demographic information is passed as a parameter. The results are inserted into a tag location of the narrative text. If the guest does not enter information for the tag during enrollment or the data source does not return content, then a default tag value is returned. The process is repeated for each tag of the exhibit narrative.

Once all of the tags have been processed, a final, and now-personalized, narrative is passed to the TTS processor for conversion into audio-stream data. The audio-stream data is generated and then transmitted to either the exhibit node for relay to the guest node, or directly to the guest node, based on the proximity of the central server, as well as the specific configuration. The audio-stream data is played out at the guest node.

In a further implementation, the central server, i.e., an application executable thereat, maintains a set of rules that govern routes between various exhibits in the exhibit area. Also, rules governing, or maintaining information, on the recommended maximum number of guests permitted at each exhibit is maintained. A list is maintained of at which exhibit each guest is positioned. At the end of the viewing by the guest of the exhibit, and hearing the content, a recommendation is generated by the application of the next exhibit for the guest to view. In generating the recommendation, the application takes into account proximity of the guest to various exhibits that the guest has not yet viewed, current guest traffic at nearby exhibits, i.e., guest usage, and guest demographics to eliminate guest congestion at certain of the exhibits. In a scenario in which multiple guests are part of a common group that are to tour the exhibit together, the audio content is further synchronized so that the guests hear the same content, determined based upon combined demographics.

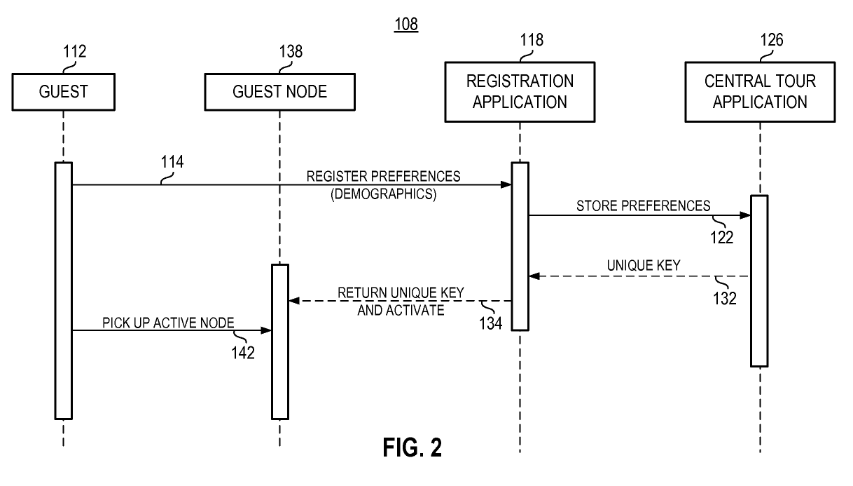

FIG. 2 illustrates a message sequence diagram, shown generally at 108, that is representative of signaling generated pursuant to registration of a guest when entering an exhibit area, such as the exhibit area 10 shown in FIG. 1. The guest 112 registers, indicated by the segment 114, guest preferences, viz., demographic information. The registration is made by way of a registration application 118 resident, e.g., by a guest enrollment station, such as the station 18 shown in FIG. 1. The demographic information is, in turn, stored, indicated by the segment 122 by way of a central tour application 126 resident, e.g., at a central server, such as the central server 26 shown in FIG. 1. The demographics forming the guest preferences are stored at a memory element at the central server, or elsewhere.

The central tour application generates a unique guest identifier, indicated by the unique key segment 132. The unique identifier is provided to the registration application 118. And, in turn, the unique key is forwarded on, together with activation commands, indicated at 134, to a guest node 138, representative, e.g., of a guest device 38 shown in FIG. 1. And, as indicated by the segment 142, the guest picks up, or is otherwise provided with, the guest node, once activated.

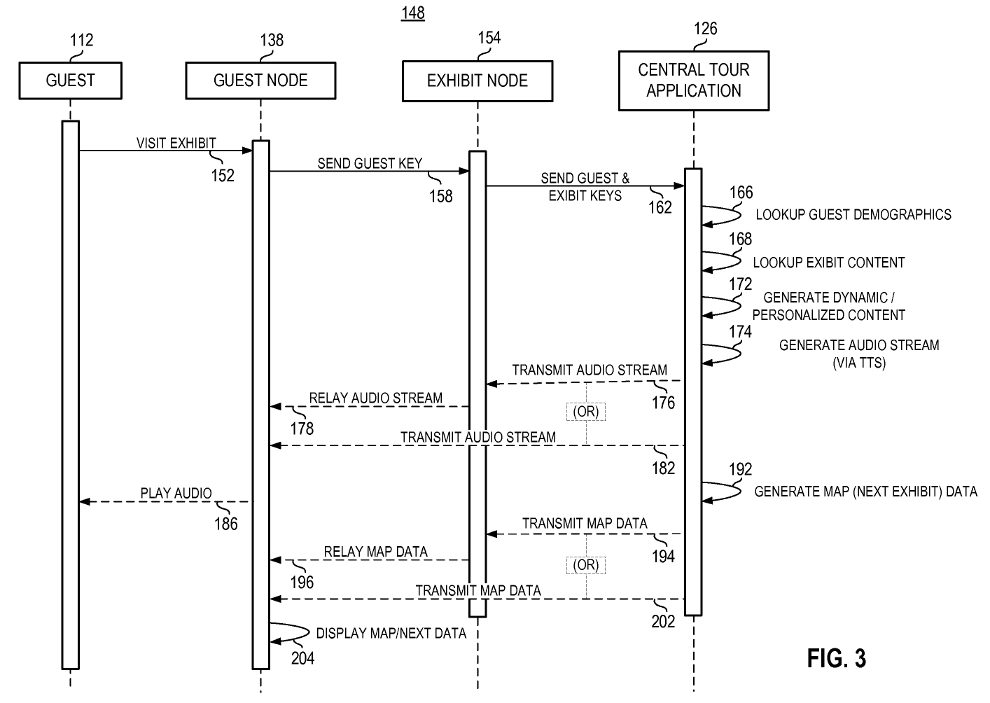

FIG. 3 illustrates a sequence diagram 148, representative of further signaling generated during operation of an embodiment of the present invention.

Here, the guest 112 visits, indicated by the segment 152, an exhibit. And, when doing so, the guest becomes positioned in proximity to the exhibit. The guest node carried by the guest is correspondingly placed in proximity with the exhibit and an exhibit node 154 associated therewith. The exhibit node 154 corresponds, e.g., to an exhibit node 14 shown in FIG. 1. When so-positioned, the guest node sends, indicated by the segment 158, the unique guest identifier, the guest key, that is detected by the exhibit node. In turn, and as indicated by the segment 162, the exhibit node sends, i.e., provides, guest and exhibit identification information, here keys, to the central tour application 126. The central tour application looks up, indicated by the segment 166, guest demographics. And, the application looks-up, indicated by the segment 168, exhibit content. The application also generates, indicated by the segment 172, dynamics/personalized content, and, as indicated by the segment 174, also generates audio-stream data.

The audio-stream data is transmitted, indicated by the segment 176, provided to the exhibit node 154, and, in turn, is relayed, indicated by the segment 178, by way of a radio air interface, to the guest node 138. Alternately, if the location of the exhibit of interest is in proximity to the central server, or elsewhere, at which central tour application generates the audio-stream data, the data is directly transmitted, indicated by the segment 182, to the guest node. And, the guest node plays out, indicated by the segment 186, the audio data to the guest. If the content further includes visual, e.g., video, content, the guest device further plays out this type of content if equipped for multi-media, or video, operation.

The sequence diagram 148 further illustrates a further implementation in which the central tour application recommends exhibit viewing by the guest. The recommendation, as noted previously, is based, e.g., upon the numbers of guests detected at various of the exhibits as well as the prior path of the guest for whom the recommendation is to be made. Here, a map is generated, indicated by the segment 192, and the central tour application generates map data that identifies a recommended next exhibit. Once created, the map data is transmitted, indicated by the segment 194, to the exhibit node 154 in proximity to the guest. And, the data is relayed, indicated by the segment 196, onto the guest node 138. The map data is alternately transmitted, indicated by the segment 202, directly to the guest node in the event that the central server at which the application 118 is resident is in proximity. Once delivered to the guest node, the recommended, next exhibit is displayed, indicated by the segment 204.

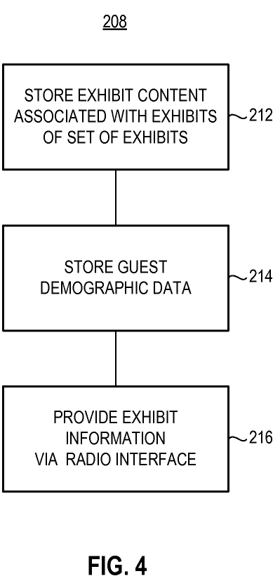

FIG. 4 illustrates a method flow diagram representative of the method of operation of an embodiment of the present invention. The method provides personalized, guest-terminated content at an exhibit area having a set of exhibits.

First, and as indicated by the block 212, exhibit content associated with each exhibit of the set of exhibits is stored. Then, and as indicated by the block 214, guest demographic data is stored.

Thereafter, and as indicated by the block 216, exhibit information is provided, at the exhibit area and by way of a radio interface, based upon exhibit content and guest demographic data.

Thereby, a manner is provided by which to improve a guest experience at an exhibit area by providing content personalized to the guest. Dynamically-obtainable data as well as conventional textual data is maintained at an exhibit content depository. Selected portions of the content are retrieved and provided as audio-stream data to the guest.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. An apparatus for providing personalized, guest-terminated content at an exhibit area having a set of exhibits, said apparatus comprising:
an exhibit content depository configured to store exhibit content associated with each exhibit of the set of exhibits;
a demographic data depository configured to store guest demographic data; and
a content provider configured to provide, at the exhibit area by way of a radio interface, exhibit information based upon the exhibit content stored at said exhibit content depository and guest demographic data stored at said demographic data depository.

2. The apparatus of claim 1 wherein said exhibit content depository is further configured to store dynamically-obtainable content information.

3. The apparatus of claim 2 wherein the dynamically-obtainable content information comprises external-link identifiers.

4. The apparatus of claim 1 wherein said content provider is further configured to provide guest-routing information.

5. The apparatus of claim 1 wherein said exhibit content depository is further configured to store the exhibit content indexed together with tagged identifiers.

6. The apparatus of claim 5 wherein said demographic data depository is configured to store individualized guest data that is associated with the tagged identifiers indexed together with the exhibit content.

7. The apparatus of claim 1 further comprising an audio converter configured to convert selected exhibit content stored at said exhibit content depository into audio stream data.

8. The apparatus of claim 7 further comprising a selector configured to select the selected exhibit content to be converted by said audio converter.

9. The apparatus of claim 8 wherein said selector is configured to select the selected exhibit content in part responsive to the guest demographic data.

10. The apparatus of claim 1 further wherein said guest demographic data further comprises unique guest-identifier data.

11. The apparatus of claim 1 wherein said guest-demographic data further comprises guest-location data.

12. The apparatus of claim 11 further comprising a guest-location data detector configured to detect the guest-location data and to provide the guest-location data, when detected, to said demographic data depository.

13. A method for providing personalized, guest-terminated content at an exhibit area having a set of exhibits, said method comprising:
storing exhibit content associated with each exhibit of the set of exhibits;
storing guest demographic data; and
providing, at the exhibit area and by way of a radio interface, exhibit information based upon exhibit content and guest demographic data.

14. The method of claim 13 wherein said providing further comprise:
retrieving selected exhibit content and sending a representation of the selected exhibit content that forms the exhibit information upon the radio interface.

15. The method of claim 14 wherein said providing further comprises converting retrieved exhibit content from textual data into audio stream data.

16. The method of claim 14 further comprising collecting the guest demographic data.

17. The method of claim 13 wherein said storing the exhibit content further comprises storing dynamically-obtainable content.

18. The method of claim 13 wherein said storing the exhibit content further comprises storing tagged exhibit content.

19. The method of claim18 wherein tags of the tagged exhibit content are associated with guest demographic data and wherein said providing comprises providing exhibit information having tags that correspond to the guest demographic data.

20. An apparatus for providing personalized content to a guest positioned at an exhibit area in proximity to an exhibit, said apparatus comprising:
a guest proximity detector configured to detect proximity of the guest to the exhibit;
an exhibit information detector configured to detect exhibit information individualized to the guest; and
an exhibit information forwarder configured to forward on the exhibit information for viewing by the guest.
